(19) United States
(12) Patent Application Publication
(10) Pub. No.: US 2020/0084084 A1
(43) Pub. Date: Mar. 12, 2020

(54) N-GRAM BASED KNOWLEDGE GRAPH FOR SEMANTIC DISCOVERY MODEL

(71) Applicant: CA, Inc., New York, NY (US)

(72) Inventors: Deepak Karunanidhi, Hyderbad (IN); Sai Eswar Garapati, Andraha Pradesh (IN); Rajat Kumar Mishra, Hyderbad (IN)

(73) Assignee: CA, Inc.

(21) Appl. No.: 16/123,522

(22) Filed: Sep. 6, 2018

(51) Int. Cl. H04L 12/24; G06F 17/27

(52) U.S. Cl. CPC H04L 41/0604; G06F 17/2785; H04L 41/069

(57) ABSTRACT

A method processing alarm messages generated by a computer network administration system includes, for each one alarm message of a plurality of alarm messages, selecting a plurality of n-grams from the one alarm message, assigning each of the plurality of n-grams to a node in a knowledge graph, generating a node weight for each node in the knowledge graph based on a popularity of the n-gram associated with the node, generating an edge weight for each of a plurality of edges connecting nodes in the knowledge graph to each other, and extracting semantic relationships between nodes in the knowledge graph based on the node weights and the edge weights. The alarm messages are grouped into clusters based on the extracted semantic relationships.

### BACKGROUND

The present disclosure relates to processing of alarm messages in computing systems, and in particular to the clustering of alarm messages based on semantic relationships using knowledge graphs.

Computer networks, particularly large, distributed computer networks, are managed by computer network management systems that receive and process alarm messages from various network elements. Alarm messages may be presented to computer administrators, who may determine what caused the alarm message and how to address it. In a large computer network, the volume of messages can become large to the point of being intractable, particularly if multiple issues arise in the computer network in a short period of time.

In such instances, it is helpful for the computer administrators to have the alarm messages organized in a manner such that related messages are grouped together so that they can be processed and addressed together, rather than as unrelated incidents. The process of grouping related alarm messages is referred to as “clustering.” Unfortunately, however, it may be difficult to determine which alarm messages are related, as many alarm messages have similar structure and content.

Some efforts have been undertaken to computationally cluster documents for various purposes, such as searching for related documents. Historically, grouping of documents has been performed by measuring syntactical relationships between the documents using schemes such as a term frequency-inverse document frequency (TF-IDF) weighting scheme. In a TF-IDF approach, both the frequency of appearance of individual words in a document and the frequency of appearance of the word in the overall corpus of documents is measured. The relative importance of a particular word in a document is determined based on its frequency of appearance in the document and its inverse frequency in the overall corpus. Thus, if a term appears frequently in a given document but infrequently overall, then the document in question is deemed to be more relevant to that term.

Using a TF-IDF approach, each document is represented as a vector of terms, and a similarity function that compares similarity of the document vectors is used to group documents into related clusters. Latent Semantic Analysis (LSA) is a technique that employs TF-IDF to analyze relationships between documents. Latent Semantic Analysis assumes that the cognitive similarity between any two words is reflected in the way they co-occur in small subsamples of the language. LSA is implemented by constructing a matrix with rows corresponding to the d documents in the corpus, and the columns labeled by the a attributes (words, phrases). The entries are the number of times the column attribute occurs in the row document. The entries are then processed by taking the logarithm of the entry and dividing it by the number of documents the attribute occurred in, or some other normalizing function. This results in a sparse but high-dimensional matrix A. Typical approaches to LSA then attempt to reduce the dimensionality of the matrix by projecting it into a subspace of lower dimension using singular value decomposition. Subsequently, the cosine between vectors is evaluated as an estimate of similarity between the terms. However, application of LSA on large datasets may be computationally challenging, and may not adequately capture semantic relationships between documents.

### SUMMARY

Some embodiments provide a method processing alarm messages generated by a computer network administration system. The method includes, for each one alarm message of a plurality of alarm messages, selecting a plurality of n-grams from the one alarm message, where n is greater than 1, assigning each of the plurality of n-grams to a node in a knowledge graph, generating a node weight for each node in the knowledge graph based on a popularity of the n-gram associated with the node, generating an edge weight for each of a plurality of edges connecting nodes in the knowledge graph to each other, and extracting semantic relationships between nodes in the knowledge graph based on the node weights and the edge weights, grouping selected ones of the plurality of alarm messages into a cluster based on the extracted semantic relationships between nodes corresponding to n-grams in the selected ones of the plurality of alarm messages.

The method may further include, before selecting the plurality of n-grams, excluding stop words from the plurality of alarm messages and performing lemmatization on remaining words in the plurality of alarm messages.

Excluding stop words may include excluding words other than nouns and verbs from the terms in the alarm messages.

The method may further include grouping selected ones of the plurality of alarm messages into plurality of clusters based on the extracted semantic relationships between nodes corresponding to n-grams in the selected ones of the plurality of alarm messages.

The method may further include providing a corpus, C, of alarm messages, dn, C={d1, d2, d3, . . . , dn} and d1, d2, d3, . . . , dn represent the alarm messages, generating a set, S, of terms in the alarm messages in the corpus, S={t1, t2, t3, . . . , tn} and t1, t2, t3, . . . , tn represent terms in the alarm messages in the corpus, and generating n-grams as sequences of terms used in the alarm messages.

Extracting the semantic relationships may include extracting a semantic relationship between a first node and a second node, and extracting a semantic relationship between a first node and a second node includes comparing an edge weight of an edge between the first node and the second node to a metric.

The metric may include an average edge weight or a median edge weight.

Extracting the semantic relationship between the first node and the second node may include comparing a node weight of the first node and a node weight of the second node to an edge weight between the nodes.

Extracting the semantic relationship between the first node and the second node may further include generating a metric based on a node weight of the first node, a node weight of the second node and the edge weight of the edge between the first node and the second node, and comparing the metric to a threshold.

Generating the edge weight between a first node and a second node may include generating the edge weight based on anterior popularity and posterior popularity of an n-gram associated with the first node and an n-gram associated with the second node.

The method may further include receiving a new alarm message, extracting a plurality of n-grams from the new alarm message, grouping the new alarm message into an existing cluster of alarm messages based on semantic relationships between nodes in the knowledge graph corresponding to n-grams in the cluster and nodes in the knowledge graph corresponding to the plurality of n-grams in the new alarm message, and displaying the new alarm message in association with the existing cluster of alarm messages.

The n-grams may include bigrams.

The method may further include, for each n-gram, calculating a background popularity metric based on popularity of the n-gram in the plurality of alarm messages and a foreground popularity metric based on popularity of the n-gram within a subset of alarm messages in the cluster, and adjusting the node weights and edge weights for each node in the knowledge graph based on the background popularity metric and foreground popularity metric of the n-gram associated with the node.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of a network management server according to some embodiments of the inventive concepts.

FIG. 3 is a block diagram illustrating a knowledge graph according to embodiments of the inventive concepts.

FIG. 4A illustrates a pair of related nodes in a knowledge graph according to embodiments of the inventive concepts.

FIG. 4B illustrates relationships between a pair of documents that are part of a corpus of documents used to generate a knowledge graph according to embodiments of the inventive concepts.

FIG. 4C illustrates grouping of documents into clusters using a knowledge graph according to embodiments of the inventive concepts.

FIGS. 5A and 5B are flowcharts illustrating operations of systems/methods in accordance with some embodiments of the inventive concepts.

FIG. 6 is a block diagram of a computing system which can be configured as a network management server according to some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Some embodiments provide systems and/or methods that employ n-gram based processing methods to extract semantic relationships between alarm messages generated in a computer network and group the alarm messages based on the discovered semantic relationships. Some embodiments use an n-gram based approach to build an enhanced knowledge graph from which semantic relationships can be extracted and used to determine similarity between alarm messages. The manual creation of an n-gram based knowledge graph from a large corpus of alarm messages is not practicable. Some embodiments provide computer-based methods that can generate n-gram based knowledge graphs from large data sets from which semantic relationships can be extracted. These relationships can be used to group alarm messages into semantically related groups that can be easier and/or more efficient to process and handle by a network administrator.

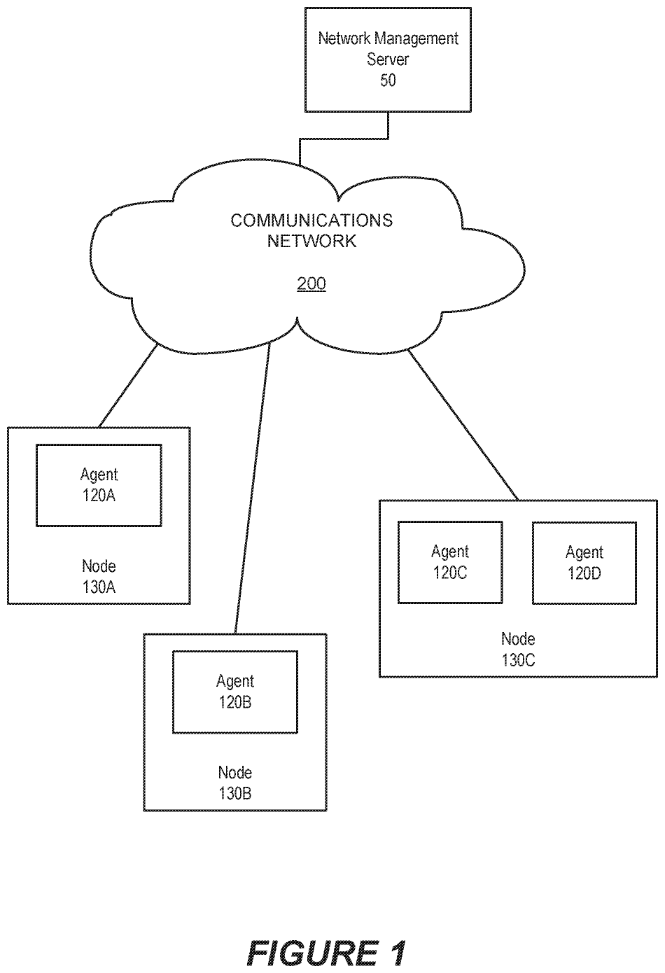

FIG. 1 is a block diagram of a distributed computing network in which systems/methods according to embodiments of the inventive concepts may be employed. Referring to FIG. 1, a plurality of nodes 130A-130D are provided. The nodes 130A-130D may be generally referred to as nodes 130. The nodes 130 may be physical devices, such as servers that have processors and associated resources, such as memory, storage, communication interfaces, etc., or virtual machines that have virtual resources assigned by a virtual hypervisor. The nodes communicate over a communications network 200, which may be a private network, such as a local area network (LAN) or wide area network (WAN), or a public network, such as the Internet. The communications network 200 may use a communications protocol, such as TCP/IP, in which each network node is assigned a unique network address, or IP address.

One or more of the nodes 130 may host one or more agents 120, which are software applications configured to perform functions in the nodes. In the distributed computing environment illustrated in FIG. 1, messages may be sent to the agents 120, which may process the messages and transmit responses to the messages.

In the distributed computing network illustrated in FIG. 1, each of the nodes 130 in the network may generate and transmit alarm messages to a network management server 50 in response to events occurring at the network elements. Alarm messages may be generated based on many different types of events, such as data transmission failures or delays, timeouts, and/or capacity, throughput, utilization or other metrics exceeding defined thresholds. When the network management server 50 receives the alarm messages, it may be helpful to group the messages semantically so that related alarm messages can be dealt with in a coordinated manner.

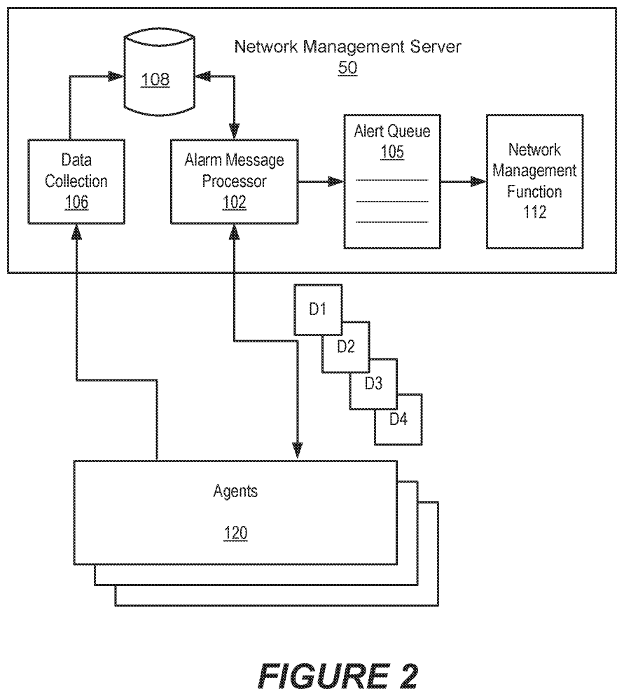

FIG. 2 is a block diagram of a network management server 50 according to some embodiments showing components of the network management server 50 in more detail. The network management server 50 includes various modules that communicate with one another to perform the workload scheduling function. For example, the network management server 50 includes a data collection module 106, an alarm message processor 102, a database 108, a network management function 112 and an alert queue 105. It will be appreciated that the network management server 50 may be implemented on a single physical or virtual machine, or its functionality may be distributed over multiple physical or virtual machines. Moreover, the database 108 may be located in the network management server 50 or may be accessible to the scheduler 100 over a communication interface. The data collection module 106 may collect data from agents 120 in the distributed computing network, and may store collected data in the database 108. From time to time, the agents 120 may generate alarm messages D1, D2, etc., and transmit the alarm messages to the network management server 50. Alarm messages typically report error conditions or other conditions that may require intervention by the network management function 112. Accordingly, alarm messages may be reported to an alarm message processor 102 which receives the alarm messages and places the alarm messages in an alert queue 105 for handling by a network management system. The alarm message processor 102 may also store the alarm messages in the database 108 for later use and/or analysis.

As noted above, one problem faced by a network management function 112 is that a very large number of alarm messages can be generated in a distributed communication network, and it can be very difficult for a network operator to process all of the alarm messages. Accordingly, in such instances, it is helpful for the computer administrators to have the alarm messages organized in a manner that related messages are grouped together so that they can be processed and addressed together, rather than as unrelated incidents, in a process known as clustering. Some embodiments described herein process alarm messages using a gram-based knowledge graph to extract semantic relationships between alarm messages that can be used to cluster the alarm messages in a semantically meaningful way. Such clustered alarm messages may then be processed by a network management function in a more efficient manner.

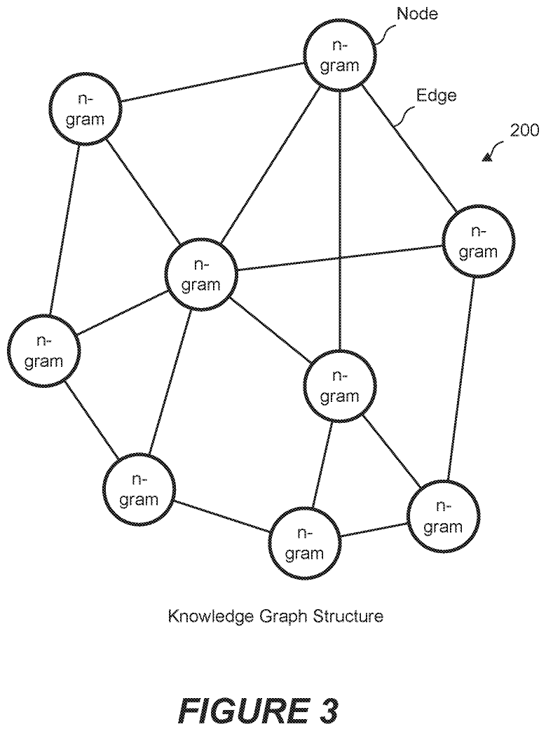

According to some embodiments, a knowledge graph may be constructed from a corpus of documents, such as alarm messages, by extracting semantically significant n-grams from the corpus and assigning each extracted n-gram to a node. Nodes in the graph that have a semantic relationship with one another are connected by edges. For example, FIG. 3 illustrates a knowledge graph 200 including a plurality of nodes, some of which are connected by edges. Each node in the knowledge graph 200 represents an n-gram extracted from a corpus of documents. In this context, an “n-gram” refers to a group of terms that appear together in one of the documents, where n>1 represents the number of words in the n-gram. Before the n-grams are extracted from a document, terms in the document other than commonly occurring words (“stop words”), such as conjunctions, definite and indefinite articles, prepositions, etc., may be grouped into n-grams that exclude the commonly occurring words. However, the excluded words may be used to establish semantic relatedness between terms. For example, terms connected by a conjunction may be considered more semantically related that terms that are not even though they may be closer together. Terms in the document may then be lemmatized, or converted to root form, before n-gram extraction. For example, following is an example of an alarm message that may be generated in a distributed computing environment:
Unable to connect to AXA Elasticsearch on LMS_TEST (reason: Connection and/or inventory update failure) {Error while reading the content from the ES for the resource name LMS_TEST}

To populate a bigram-based knowledge graph based on this message, the message is first grouped into related bigrams (i.e. two-word phrases) shown in Table 1 while excluding stop words:

TABLE 1
Extracted bigrams

| Bigram | Term 1 | Term 2 |
|---|---|---|
| 1 | unable | connect |
| 2 | connect | axa |
| 3 | axa | elasticsearch |
| 4 | elasticsearch | lms_test |
| 5 | lms_test | reason |
| 6 | reason | connection |
| 7 | connection | inventory |
| 8 | inventory | update |
| 9 | update | failure |
| 10 | failure | error |
| 11 | error | reading |
| 12 | reading | content |
| 13 | content | es |
| 14 | es | resource |
| 15 | resource | name |
| 16 | name | lms_test |

After lemmatization, the bigrams appear as shown in Table 2.

TABLE 2
Extracted bigrams after lemmatization

| Bigram | Term 1 | Term 2 |
|---|---|---|
| 1 | unable | connect |
| 2 | connect | axa |
| 3 | axa | elasticsearch |
| 4 | elasticsearch | lms_test |
| 5 | lms_test | reason |
| 6 | reason | connect |
| 7 | connect | inventory |
| 8 | inventory | update |
| 9 | update | fail |
| 10 | fail | error |
| 11 | error | read |
| 12 | read | content |
| 13 | content | es |
| 14 | es | resource |
| 15 | resource | name |
| 16 | name | lms_test |

Each of the bigrams shown in Table 2 may be assigned to a node in the knowledge graph. Since each of the bigrams appears in the same alarm message, an edge is drawn between the two nodes associated with the bigrams, and a weight may be assigned to the edge. The edge weight may be assigned, for example, based on a number of words (distance) between the two terms in the alarm message. Thus, for example, an edge between the bigrams “unable connect” and “axa elaticsearch” would have a higher edge weight than an edge between the terms “unable connect” and “inventory update.” If the alarm message shown above were being processed to supplement an existing knowledge graph, then already existing edge weights may be increased or decreased based on the distance between the nodes in this alarm message.

Weights may be assigned to individual nodes to indicate the relative importance of the node in a particular corpus or cluster of documents. The weight of a node may be based, in some embodiments, on a term frequency-inverse document frequency analysis that takes into account the frequency of occurrence of the term in both the document in question and the overall corpus of documents.

In this manner, an n-gram based knowledge graph may be generated by analyzing a corpus of alarm messages, which may include thousands or even millions of alarm messages. Because the alarm message is analyzed as a collection of n-grams instead of individual terms, semantic relationships among documents in the corpus may be more efficiently identified.

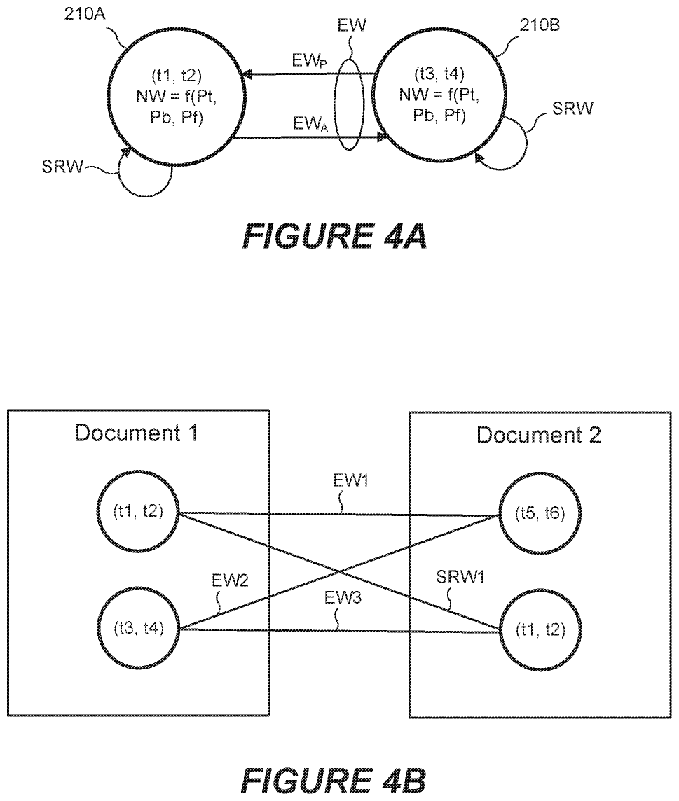

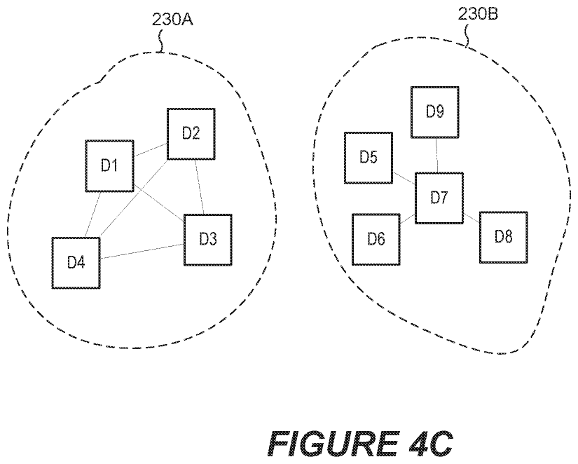

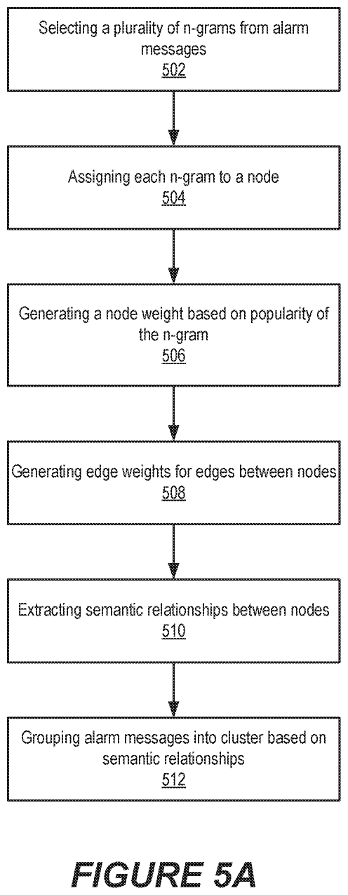

Moreover, some embodiments enable the discovery of deeper semantic relationships by analyzing both forward and reverse relatedness between bigrams. For example, FIG. 4A illustrates an approach to assigning node weights and edge weights that can enable more accurate and/or efficient identification of semantic relatedness. In particular, FIG. 4A illustrates two nodes, 210A, 210B of a knowledge graph. The node 210A is associated with a bigram (t1, t2) consisting of terms t1 and t2, while the node 210B is associated with a bigram (t3, t4) consisting of terms t3 and t4. The edge weight between the nodes comprises a vector (EW_{P}, EW_{A}) of edge weights including an anterior edge weight EW_{A} and a posterior edge weight EW_{P}, as viewed from the standpoint of the first node.

The anterior edge weight EW_{A} and posterior edge weight EW_{P} provide a measure of how related the terms are based on their order of appearance. That is, from the standpoint of the first node, the anterior edge weight EW_{A} is strengthened when the first n-gram appears more often and closer before the second n-gram, while the posterior edge weight EW_{P} is strengthened when the second n-gram appears more often and closer before the first n-gram. For example, in the above example, if the bigram “axa elasticsearch” appears more often after the bigram “unable connect” than before it, then the anterior edge weight between the nodes “unable connect” and “axa elasticsearch” may be stronger than the posterior edge weight. By assigning both anterior and posterior edge weights between node, semantic relationships between nodes may be more fully characterized, allowing for more efficient identification of semantic relationships between documents containing such terms.

Each node may also be characterized by a self-referential weight (SRW), which may simply be the node weight or a function of the node weight. The SRW may be used in the process of evaluating semantic relatedness as described in more detail below.

Node weights may also be generated in some embodiments in a way that enables more efficient characterization of semantic relationships. As shown in FIG. 4A, node weights (NW) of the nodes may be generated as a function of total popularity (Pt), background popularity (Pb) and foreground popularity (Pf). Total popularity may be calculated based on TF-IDF as described above. Background and foreground popularity may be calculated based on popularity of an n-gram within a set of documents for which a node associated with the n-gram has greater than a threshold initial node weight (foreground popularity) and popularity of the n-gram within a set of documents for which the node associated with the n-gram has less than a threshold initial node weight (background popularity). Other metrics for calculating node weight may be employed within the scope of the inventive concepts.

Some embodiments extract semantic relationships between nodes in the knowledge graph. In particular, some embodiments may extract semantic relationships between nodes by comparing an edge weight of an edge between a first node and a second node to a threshold metric, such as an average edge weight or a median edge weight. In some embodiments, a semantic relationship between a first node and a second node may be extracted by comparing a node weight of the first node and a node weight of the second node to an edge weight between the nodes.

Extracting the semantic relationship between the first node and the second node may further include generating a metric based on a node weight of the first node, a node weight of the second node and the edge weight of the edge between the first node and the second node, and comparing the metric to a threshold.

Once a knowledge graph has been created with associated node weights and edge weights, in some embodiments, a total semantic weight may be generated for each document in the corpus by, for example, generating a sum of all node weights of all nodes associated with n-grams in the document. In some embodiments, the total semantic weight of a document may be generated by generating a sum of all node weights of all nodes associated with n-grams in the document and all edge weights between nodes associated with n-grams in the document. Other metrics for calculating the total semantic weight of a document may be employed within the scope of the inventive concepts.

In addition, one or more relatedness metrics may be generated for each pair of documents in the corpus that was used to create the knowledge graph by analyzing n-grams in the documents associated with nodes in the knowledge graph that are connected by an edge. One relatedness metric may be generated based by iterating through each n-gram in each document and evaluating edge weights and/or node weights of common and/or connected nodes associated with the n-grams. For example, referring to FIG. 4B, an example is illustrated including two documents, Document 1 and Document 2. Document 1 includes two bigrams having associated nodes (t1, t2) and (t3, t4). Document 2 also includes bigrams having associated nodes including one node (t1, t2) that is found in Document 1 and a node (t5, t6) that is not found in Document 1. From the knowledge graph, it is determined whether node in Document 1 has a semantic relationship with nodes in Document 2, and vice versa, based on whether an edge exists in the knowledge graph between the two nodes. For example, node (t1, t2) in Document 1 has an edge weight (EW1) with node (t5, t6) in Document 2 and a self-referential weight (SRW1) associated with itself (t1, t2) in Document 2. Likewise, node (t3, t4) in Document 1 has an edge weight (EW2) with node (t5, t6) in Document 2 and an edge weight (EW3) with node (t1, t2) in Document 2.

A metric of semantic relatedness may be generated by summing the edge weights or self-referential weights between nodes in Document 1 and Document 2. For example, a metric SS of semantic similarity between documents D1 and D2 may be generated by evaluating the following equation:

SS=EW1+EW2+EW3+SRW1 [1]

More generally, the semantic similarity (SS) between Documents 1 and 2 may be expressed as the sum of all n edge weights that exist between nodes associated with n-grams in the two documents:

SS=μᵢ₌₁ⁿEWᵢ [2]

where the edge weight between nodes corresponding to the same n-gram are self-referential weights. Other formulas may be used within the scope of the inventive concepts.

In some embodiments, the metric of semantic similarity may be normalized to a value between 0 and 100 according to the following formula:

$$SS = \frac{{\sum }_{i = 1}^{n} {EW}_{i}}{MAX ( SS )} \times 100 \qquad [ 3 ]$$

where MAX SS is the maximum semantic similarity across all documents in the corpus.

Some embodiments evaluate the semantic similarity between all documents in a corpus, such as all alarm messages received by a particular network management server or all alarm messages transmitted in a distributed computing system over a period of time. Once the semantic similarity between documents has been generated, the semantic similarity may be used to group documents in the corpus into clusters. Referring to FIG. 4C, two clusters 230A, 230B including a plurality of documents are shown. Many different algorithms can be used to group documents into a cluster. For example, in some embodiments, documents in the corpus can be ranked based on total semantic weight and then, starting with the document having the highest total semantic weight, grouping all documents having a semantic similarity with the starting document higher than a given threshold into a cluster, and repeating the process for the remaining documents. For example, assume a corpus of ten documents with associated total semantic weights as shown in Table 3.

TABLE 3
Example documents in a corpus

| Document | Total Semantic Weight |
|---|---|
| D1 | 280 |
| D2 | 310 |
| D3 | 110 |
| D4 | 190 |
| D5 | 440 |
| D6 | 250 |
| D7 | 260 |
| D8 | 180 |
| D9 | 390 |
| D10 | 200 |

Ranking the documents by semantic weight yields the result shown in Table 4.

TABLE 4
Example documents in a corpus ranked by total semantic weight

| Document | Total Semantic Weight |
|---|---|
| D5 | 440 |
| D9 | 390 |
| D2 | 310 |
| D1 | 280 |
| D7 | 260 |
| D6 | 250 |
| D10 | 200 |
| D4 | 190 |
| D8 | 180 |
| D3 | 110 |

Taking document D5 as the document having the highest total semantic weight, the remaining documents are then ranked according to semantic similarity to document D5, resulting in the result shown in Table 5.

TABLE 5
Remaining ranked by semantic similarity to D5

| Document | Semantic Similarity to D5 |
|---|---|
| D8 | 95 |
| D6 | 90 |
| D2 | 75 |
| D9 | 60 |
| D3 | 45 |
| D1 | 30 |
| D10 | 20 |
| D7 | 10 |
| D4 | 10 |

A cluster may then be generated by grouping all documents having a semantic similarity to D5 greater than a predetermined threshold. For example, if the threshold is set at 70, then documents D2, D6 and D8 may be grouped into a cluster with D5. The process may then be repeated with the remaining ungrouped documents (D1, D3, D4, D7, D9 and D10) until all documents have been placed into a cluster or until no more documents remain to be grouped. For example, the process would select document D9 as the document having the highest total semantic weight of the remaining documents, and then group all documents having a semantic similarity of 70 or more with document D9 into a second cluster, and so on.

An approach such as that described above may generate a cluster such as the cluster 230B shown in FIG. 4C, as that cluster requires all documents in the cluster to have at least a predetermined semantic similarity only with a single document, but not necessarily with each other. Other approaches to clustering may require all documents in the cluster to have at least a predetermined semantic similarity with every other document in the cluster, such as shown in cluster 230A in FIG. 4C. Many different clustering algorithms are possible within the scope of the inventive concepts.

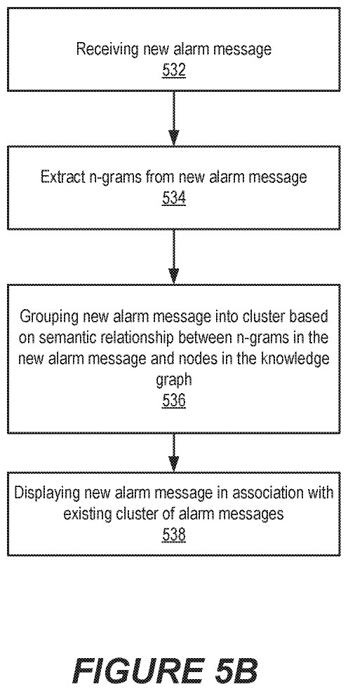

FIG. 5A is a flowchart illustrating a method of processing alarm messages in a computer network administration system according to some embodiments. The method includes, for each one alarm message of a plurality of alarm messages, selecting a plurality of n-grams from the one alarm message, where n is greater than 1 (block 502). Each of the plurality of n-grams is assigned to a node in a knowledge graph (block 504). A node weight is generated for each node in the knowledge graph based on a popularity of the n-gram associated with the node (block 506), and an edge weight is generated for each of a plurality of edges connecting nodes in the knowledge graph to each other (block 508). The method extracts semantic relationships between nodes in the knowledge graph based on the node weights and the edge weights (block 510) and groups selected ones of the plurality of alarm messages into a cluster based on the extracted semantic relationships between nodes corresponding to n-grams in the selected ones of the plurality of alarm messages (block 512).

Before the plurality of n-grams are selected, the method may exclude stop words from the plurality of alarm messages and perform lemmatization on remaining words in the plurality of alarm messages. In some embodiments, stop words may include any words other than nouns and verbs in the alarm messages.

The method may further include grouping selected ones of the plurality of alarm messages into plurality of clusters based on the extracted semantic relationships between nodes in the alarm messages corresponding to n-grams in the selected ones of the plurality of alarm messages.

The method may further include providing a corpus, C, of alarm messages, dn, C={d1, d2, d3, . . . , dn} and d1, d2, d3, . . . , dn represent the alarm messages, generating a set, S, of terms in the alarm messages in the corpus, S={t1, t2, t3, . . . , tn} and t1, t2, t3, . . . , tn represent terms in the alarm messages in the corpus, and generating n-grams as sequences of terms used in the alarm messages. In some embodiments, the method may generate a metric of semantic similarity between each pair of documents (d1, d2) in the corpus, and the clusters may be generated based on the metric of semantic similarity between the documents.

Extracting the semantic relationship between a first node and a second node may be performed by comparing an edge weight of an edge between the first node and the second node to a threshold metric. The threshold metric may include an average edge weight or a median edge weight.

Extracting the semantic relationship between the first node and the second node may further include generating a metric based on a node weight of the first node, a node weight of the second node and the edge weight of the edge between the first node and the second node, and comparing the metric to a threshold.

Referring to FIG. 5B, the method may further include receiving a new alarm message from a node in the computing system (532), extracting a plurality of n-grams from the new alarm message (534), grouping the new alarm message into an existing cluster of alarm messages based on semantic relationships between nodes in the knowledge graph corresponding to n-grams in the cluster and nodes in the knowledge graph corresponding to the plurality of n-grams in the new alarm message (536), and displaying the new alarm message in association with the existing cluster of alarm messages (538).

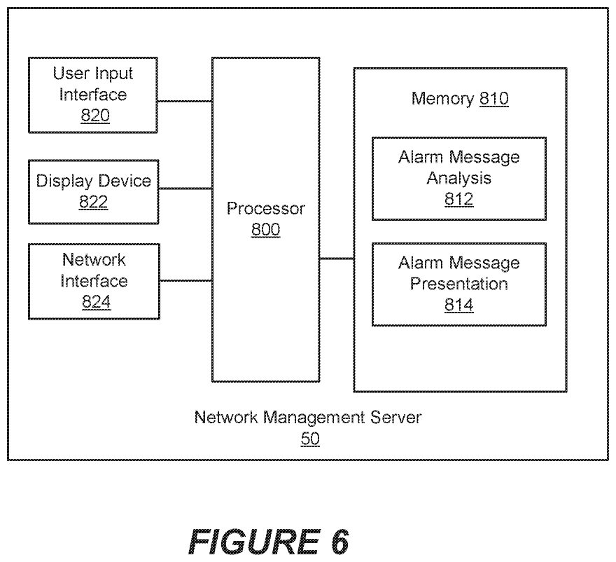

FIG. 6 is a block diagram of a device that can be configured to operate as the network management server 50 according to some embodiments of the inventive concepts. The network management server 50 includes a processor 800, a memory 810, and a network interface 824, which may include a radio access transceiver and/or a wired network interface (e.g., Ethernet interface).

The processor 800 may include one or more data processing circuits, such as a general purpose and/or special purpose processor (e.g., microprocessor and/or digital signal processor) that may be collocated or distributed across one or more networks. The processor 800 is configured to execute computer program code in the memory 810, described below as a non-transitory computer readable medium, to perform at least some of the operations described herein. The computer 800 may further include a user input interface 820 (e.g., touch screen, keyboard, keypad, etc.) and a display device 822.

The memory 810 includes computer readable code that configures the network management server 50 to implement the data collection component 106, the alarm message processor 102, the alert queue 105 and the network management function 112. In particular, the memory 810 includes alarm message analysis code 812 that configures the network management server 50 to analyze and cluster alarm messages according to the methods described above and alarm message presentation code 814 that configures the network management server to present alarm messages for processing based on the clustering of alarm messages as described above.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of processing alarm messages in a computer network administration system, comprising:
for each one alarm message of a plurality of alarm messages:
selecting a plurality of n-grams from the one alarm message, where n is greater than 1;
assigning each of the plurality of n-grams to a node in a knowledge graph;
generating a node weight for each node in the knowledge graph based on a popularity of the n-gram associated with the node;
generating an edge weight for each of a plurality of edges connecting nodes in the knowledge graph to each other; and
extracting semantic relationships between nodes in the knowledge graph based on the node weights and the edge weights; and
grouping selected ones of the plurality of alarm messages into a cluster based on the extracted semantic relationships between nodes corresponding to n-grams in the selected ones of the plurality of alarm messages.

2. The method of claim 1, further comprising:
before selecting the plurality of n-grams, excluding stop words from the plurality of alarm messages and performing lemmatization on remaining words in the plurality of alarm messages.

3. The method of claim 2, wherein excluding stop words comprises excluding words other than nouns and verbs from the terms in the alarm messages.

4. The method of claim 1, further comprising:
grouping selected ones of the plurality of alarm messages into plurality of clusters based on the extracted semantic relationships between nodes corresponding to n-grams in the selected ones of the plurality of alarm messages.

5. The method of claim 1, further comprising:
generating a metric of semantic similarity between each pair of alarm messages, wherein grouping the alarm messages into clusters is performed based on the metric of semantic similarity.

6. The method of claim 1, wherein extracting the semantic relationships comprises extracting a semantic relationship between a first node and a second node, and wherein extracting a semantic relationship between a first node and a second node comprises comparing an edge weight of an edge between the first node and the second node to a metric.

7. The method of claim 7, wherein the metric comprises an average edge weight or a median edge weight.

8. The method of claim 6, wherein extracting the semantic relationship between the first node and the second node further comprises comparing a node weight of the first node and a node weight of the second node to an edge weight between the first node and the second node.

9. The method of claim 6, wherein extracting the semantic relationship between the first node and the second node further comprises:
generating a metric based on a node weight of the first node, a node weight of the second node and the edge weight of the edge between the first node and the second node; and
comparing the metric to a threshold.

10. The method of claim 1, wherein generating the edge weight between a first node and a second node comprises:
generating the edge weight based on anterior popularity and posterior popularity of an n-gram associated with the first node and an n-gram associated with the second node.

11. The method of claim 1, further comprising:
receiving a new alarm message;
extracting a plurality of n-grams from the new alarm message;
grouping the new alarm message into an existing cluster of alarm messages based on semantic relationships between nodes in the knowledge graph corresponding to n-grams in the cluster and nodes in the knowledge graph corresponding to the plurality of n-grams in the new alarm message; and
displaying the new alarm message in association with the existing cluster of alarm messages.

12. The method of claim 1, wherein the n-grams comprise bigrams.

13. The method of claim 1 further comprising:
for each n-gram, calculating a background popularity metric based on popularity of the n-gram in the plurality of alarm messages and a foreground popularity metric based on popularity of the n-gram within a subset of alarm messages in the cluster; and
adjusting the node weights and edge weights for each node in the knowledge graph based on the background popularity metric and foreground popularity metric of the n-gram associated with the node.

14. A network management server comprising:
a processing circuit; and
a memory coupled to the processing circuit, the memory comprising machine-readable instructions that, when executed by the processing circuit cause the processing circuit to:
for each one alarm message of a plurality of alarm messages:
select a plurality of n-grams from the one alarm message, where n is greater than 1;
assign each of the plurality of n-grams to a node in a knowledge graph;
generate a node weight for each node in the knowledge graph based on a popularity of the n-gram associated with the node;
generate an edge weight for each of a plurality of edges connecting nodes in the knowledge graph to each other; and
extract semantic relationships between nodes in the knowledge graph based on the node weights and the edge weights; and
group selected ones of the plurality of alarm messages into a cluster based on the extracted semantic relationships between nodes corresponding to n-grams in the selected ones of the plurality of alarm messages.

15. The network management server of claim 14, wherein the machine-readable instructions further cause the processing circuit to:
group selected ones of the plurality of alarm messages into plurality of clusters based on the extracted semantic relationships between nodes corresponding to n-grams in the selected ones of the plurality of alarm messages.

16. The network management server of claim 14, wherein the machine-readable instructions further cause the processing circuit to:
generating a metric of semantic similarity between a pair of alarm messages in a corpus of alarm messages; and
group the alarm messages into clusters based on the metric of semantic similarity.

17. The network management server of claim 14, wherein extracting the semantic relationships comprises extracting a semantic relationship between a first node and a second node, and wherein extracting a semantic relationship between a first node and a second node comprises comparing an edge weight of an edge between the first node and the second node to a metric.

18. The network management server of claim 17, wherein extracting the semantic relationship between the first node and the second node further comprises:
generating a metric based on a node weight of the first node, a node weight of the second node and the edge weight of the edge between the first node and the second node; and
comparing the metric to a threshold.

19. The network management server of claim 14, wherein generating the edge weight between a first node and a second node comprises:
generating the edge weight based on anterior popularity and posterior popularity of an n-gram associated with the first node and an n-gram associated with the second node.

20. The network management server of claim 14, wherein the machine-readable instructions further cause the processing circuit to:
receive a new alarm message;
extract a plurality of n-grams from the new alarm message;
group the new alarm message into an existing cluster of alarm messages based on semantic relationships between nodes in the knowledge graph corresponding to n-grams in the cluster and nodes in the knowledge graph corresponding to the plurality of n-grams in the new alarm message; and
display the new alarm message in association with the existing cluster of alarm messages.
